(19) United States
(12) Patent Application Publication
(10) Pub. No.: US 2010/0329116 A1
(43) Pub. Date: Dec. 30, 2010

(54) Conflict avoidance with transmission timing and path mutually restrained responsively to wireless environment changing

(75) Inventor: Masaaki Date, Osaka (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 12/801,096

(22) Filed: May 21, 2010

(30) Foreign Application Priority Data
Jun. 25, 2009 (JP) 2009-151075

(51) Int. Cl. H04W 28/02; H04W 28/10

(52) U.S. Cl. 370/235; 370/338

(57) ABSTRACT

A communication control apparatus is adaptive to changes in a wireless communication environment to control transmission timing and path reciprocally between network nodes to thereby avoid transmission collisions and congestions. A transmission timing control calculator contends with other nodes for a band to transmit a data signal to control a transmission timing of its own node. A path control calculator determines transmission paths for transmitting data signals within the bandwidth for the own node obtained by the transmission timing control calculator. A data signal transmitter transmits a data signal to a destination node on each transmission path determined by the path control calculator. The transmission timing control calculator and the path control calculator provide each other with state information on processing, and use the provided state information as a constraint condition to control the bands of the own node and of links between the own and destination nodes.

### BACKGROUND OF. THE INVENTION

1. Field of the Invention

The present invention relates to a communication control apparatus, and more particularly to such an apparatus for use in a telecommunications network node connected to form a sensor network or a local area network (LAN) together with other nodes distributed in a space or installed on mobile bodies or the like for avoiding collisions or congestions of transmission data due to radio interference or the like during data transmission between the nodes.

2. Description of the Background Art

Some solutions for avoiding transmission collisions are disclosed in U.S. patent application publication No. US 2005/0190796 A1 to Date et al., Japanese patent laid-open publication Nos. 2006-74617 and 2006-74619, U.S. Pat. Nos. 7,460,631, 7,626,946 and 7,649,871, all to Date et al., and U.S. patent application publication No. US 2006/0171421 A1 to Matsunaga et al. These solutions do not require a centralized management server but can avoid transmission collisions by autonomous-distributed scheduling of a transmission timing executed by individual nodes. Furthermore, a congestion control technique is known by Hidenori AOKI et al., “The Core of Wireless Broadband—IEEE802.11s (sequel): Routing Protocol for Wireless Communications—Congestion Control Technique to Expand Network Capacity”, Nikkei Business Publications, Inc., Jun. 15, 2006, pp. 86-93.

In the conventional solutions disclosed in the above publications, each node periodically transmits and receives a control packet, or control information on the transmission timing of the own node, to and from its neighboring nodes so as to control the transmission timing reciprocally. The transmission cycle, or time interval, of a control packet is hereinafter referred to simply as cycle.

The reciprocal control of the transmission timing makes the neighboring nodes selectively own the divided sections of a period of one cycle to thereby allow each node to acquire a temporal section, or share, required by that node for data transmission. Within one cycle, the temporal sections to be used for transmission by the nodes correspond to phase sections for use in the operation of the transmission timing control. More specifically, the time sections defining the transmission timing are dealt with as phases in the control operation. Hereinafter, the temporal section or phase section used by a node for data transmission in one cycle is referred to as a band obtained by that node. Likewise, the duration of a temporal section or phase section is referred to as a bandwidth.

There are also some solutions for transmitting and receiving control packets between neighboring nodes. With reference to FIGS. 2A and 2B, such a solution for transmitting/receiving control packets between neighboring nodes will be described.

FIG. 2A schematically shows telecommunications nodes 51 residing in the prior art system of such a solution. As shown in the figure, the reaching, or available, area 53 of a radio wave of control packets transmitted from a node of interest 51i is expanded broader than that 55 of data packets therefrom, e.g. the former is approximately twice as large as the latter. In this case, the adjustment of the transmission power ratio between control packets and data packets renders the ratio of the servicing areas 53 and 55 between both radio waves to be set to an appropriate value. The ratio of the servicing areas 53 and 55 between both radio waves is adjusted in this way in order to avert the occurrence of transmission collision caused by, a hidden node or the like.

Also FIG. 2B schematically shows another solution. Specifically, in the illustrated solution, the reaching area, or zone, 57 of the radio waves of control packets and data packets is equal to each other, i.e. these packets have equal transmission power, and a node of interest 51i generates, when having received a control packet from another node 51, a virtual phase model and transmits its own control packet with the virtual phase added thereto, see the '946 patent to Date et al.

Among the nodes 51a having received a control packet from the subject node, or node of interest, 51i, i.e. existing inside the circle 57 shown in FIG. 2B, ones, when having no virtual phase model with respect to the subject node 51i therein, newly generate a virtual phase model, and others, when having a virtual phase model therein, adjust the value of the virtual phase model. The value of the virtual phase models thus generated or adjusted varies afterward at a constant rate corresponding to the specific angular oscillation frequency. When the nodes 51a send out respective control packets, they add to the control packet the value of the virtual phase model for the subject node 51i at the current time. That enables the phase information of the subject node 51i to be indirectly transmitted via the nodes 51a neighboring in one hop, namely in the circle 57 in FIG. 2B, to the nodes 51b residing in two-hop neighborhood, i.e. within the circles 59 but not in the circle 57 in the figure.

The above description is made on the mechanism of the indirect transmission of the phase information of the subject node to the nodes locating in two hops from the subject node. Such an interactive transmission is also applicable to transmitting the phase information of all other nodes to the nodes in two-hop neighborhood. That means that the interaction areas 59 in the transmission timing control cover the areas up to two-hop neighborhood of each node.

In the following, a description will be made on a solution for transmitting and receiving control packets between the neighboring nodes in the system illustrated in FIG. 2B, only for convenience in explanation. The present invention, which will be described later, can also be applied to the system shown in FIG. 2A. For the description purpose, each node is assumed to be notified in advance of the number of hops from a data sink node. The number of hops can be notified in the following way. First, the sink node transmits a packet equivalent to a control packet to each node. The packet is forwarded by multi-hop while the number of forwards is counted. Each node observes the number of hops until the packet reaches each node. Each node stores the minimum value of the number of hops observed in that node as the number of hops from that node to the sink node. By carrying out the preprocess in advance, the number of hops can be notified to the nodes.

In multi-hop communications employed by a sensor network and the equivalent, the length of a time period required for data packet transmission is generally different node by node. For example, in a network in which sensor data observed by each node is transmitted to a sink node by multi-hop, the nodes closer to the sink node tend to be higher in transmission or communication load of data packets forwarded from other nodes. Thus, the nodes closer to the sink node require the longer duration of the temporal section, or bandwidth, for data transmission. When any of the transmission timing control solutions disclosed in the above-mentioned conventional patent documents is applied to the above network, the following practically serious problems will be come up.

Assume that, e.g. an obstacle is involved in multi-hop communications over a network established by any of the transmission timing control solutions described in the above conventional patent documents t cause the wireless network environment to change and a node A having heavy communication load tries to change the destination of a data packet from a node B to a node C due to the change. That causes the communication load on the node C, namely the bandwidth required by the node C for data transmission, to abruptly increase.

However, when the above transmission timing control solutions are used, it is necessary to readjust the transmission timing between the node C and its neighboring nodes, which often takes time to obtain a necessary bandwidth. This is because the neighboring nodes go into competition with each other due to overlapping between the respective necessary bandwidths, and it takes long to dissolve the competition.

As a consequence, the data packets which cannot be sent out in one cycle are accumulated in the node C, resulting in packet loss or congestion induced by buffer overflow. It leads to the deterioration of the reliability of data transmission.

In the case where the node C operates on a battery, another problem arises in the conventional arts. That is, if the communication load increases already under the heavy communication load in the node C as described above, i.e. the load concentrated on that particular node, the battery of the node C goes dead much quicker than those of the other nodes. That causes the increase in the maintenance cost such as battery replacement, bringing significant disadvantages in the system operation.

### SUMMARY OF THE INVENTION

It is an object of the present invention to provide a communication control apparatus capable of preventing the communication load of a node from increasing even when a wireless communication environment changes while being adaptive to changes in a wireless communication environment to control the transmission timing and path reciprocally between nodes to thereby avoid transmission collisions and congestions.

In accordance with the present invention, a communication control apparatus for use in an own network node forming a wireless communication network together with another network node comprises a transmission timing control calculator for contending with other nodes for a band in which a data signal is transmitted to control a transmission timing of the own node, a path control calculator for determining one or more transmission paths for transmitting respective data signals within a bandwidth obtained for the own node by the transmission timing control calculator, and a data signal transmitter for transmitting the data signal to a destination node on each transmission path determined by the path control calculator. The transmission timing control calculator and the path control calculator provide each other with respective state information on processing, and use the provided state information as a constraint condition to control the band of the own node and bands of links between the own node and the destination nodes.

Thus, the present invention has the advantages of reducing the increase in communication load of a node even when a wireless communication environment changes, and controlling transmission timing and path reciprocally between nodes while being adaptive to changes in a wireless communication environment to thereby avoid transmission collisions and congestions.

The inventive concept disclosed in the application may also be defined in ways other than in the claims presented below. The inventive concept may consist of several separate inventions particularly if the invention is considered in light of explicit or implicit subtasks or from the point of view of advantages achieved. In such a case, some of the attributes included in the claims may be superfluous from the point of view of separate inventive concepts. Within the framework of the basic inventive concept, features of different embodiments are applicable in connection with other embodiments.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing the internal configuration of a wireless communication node according to a preferred embodiment of the present invention;

FIGS. 2A and 2B show nodes in wireless communication systems useful for understanding transmission and reception patterns of control packets between conventional nodes;

FIG. 3 is a schematic diagram useful for understanding the essential concept of the present invention;

FIG. 4 plots an example of phase response function in a communication timing calculator according to the preferred embodiment; and

FIG. 5 is a schematic chart of phase plain useful for understanding the bandwidths of links obtained by the own node to other nodes in the preferred embodiment.

### DESCRIPTION OF THE PREFERRED EMBODIMENTS

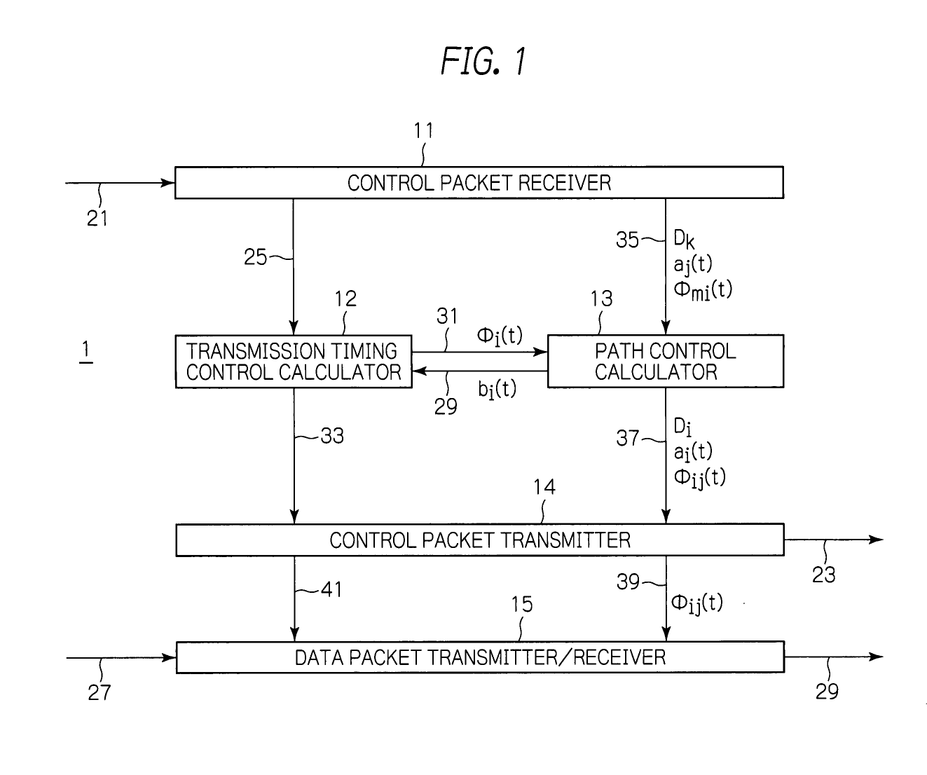

With reference to FIG. 1, a preferred embodiment of a communication control apparatus in accordance with the present invention will be described in detail. In the preferred embodiment, the apparatus of the present invention is applied to a wireless communication system in which a number of nodes distributed in a space or installed on mobile bodies or the like transmit data with one another by means of multi-hop communication technique.

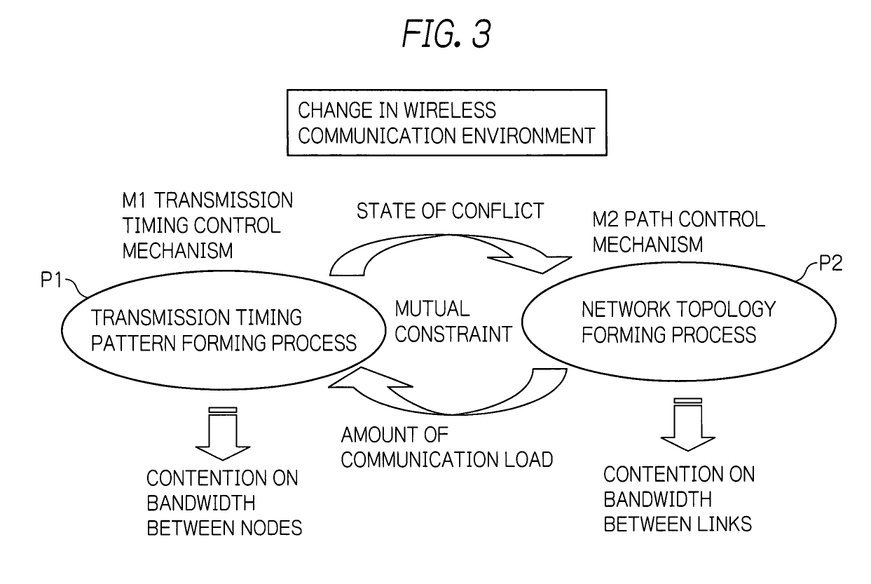

A description will be made with reference first to FIG. 3, which schematically shows the conceptual basis of communication control in accordance with the present invention. Specifically, the concept of the communication control method is shown in the figure, in which a wireless communication node controls transmission timings and paths to other wireless communication nodes reciprocally in response to changes in the wireless network environment.

In this figure, a transmission timing control mechanism M1 functions as controlling transmission timings to be mutually shifted between the nodes. A transmission timing pattern forming process P1 shifts transmission timings between the nodes according to the operation of the transmission timing control mechanism M1. The transmission timings have to be shifted between the nodes by the time required for transmitting a data packet. If the time duration of the shifts is not longer than the required value, transmission collisions would then occur between the nodes. The transmission timing pattern forming process P1 is therefore a process where the nodes contend for a required communication band.

A path control mechanism M2 functions as controlling the transmission path of data packets over a wireless communication network. A network topology forming process P2 determines the transmission path of data packets over the network in response to the path control mechanism M2. In the present invention, the process P2 corresponds to a process where links between the nodes contend for a communication band, which will be described in detail later.

The present invention is specifically featured as both processes constraining one another in response to changes in the wireless network environment to gradually go on establishing a relationship to compromise with each other.

In general, when a transmission path on a network changes, the communication loads on the respective nodes change, which cause a change in bandwidth required by each node. Thus, the determination of transmission paths is a condition of constraint in the transmission timing pattern forming process P1.

The transmission timing pattern forming process P1 involves collisions and competition, both referred to as conflict, of transmission timing between the nodes. In the illustrative embodiment, the state of the conflict occurring in the transmission timing pattern forming process P1 is fed back as the constraint condition to the network topology forming process P2. More specifically, the state of a conflict occurring in the course of contention between the nodes for a band needed for data transmission has an effect on the process of determining a transmission path of data packets so as to decrease the possibility of conflict.

In this way, the processes P1 and P2 proceed, while constraining one another, so as to gradually go on establishing a relationship to compromise with each other. Consequently, the system quickly adapts itself to changes in the wireless communication environment to thereby allow the nodes to reciprocally control the transmission timing and path therebetween, thereby achieving a multi-hop communication while avoiding the transmission collisions and congestions.

Now, with reference to FIG. 1, schematically showing the internal configuration of a wireless communication node 1 according to the illustrative embodiment, the node 1 comprises at least a control packet receiver 11, a transmission timing control calculator 12, a path control calculator 13, a control packet transmitter 14 and a data packet transmitter/receiver 15, which are interconnected as illustrated.

The illustrative embodiment of the node 1 is depicted and described as configured by separate functional blocks. It is however to be noted that such a depiction and a description do not restrict the node 1 to an implementation only in the form of hardware but the node may partially or entirely be implemented by software, namely, by a computer, or processor system, which has a computer program installed and functions, when executing the computer program, as part of, or the entirety of, the node. In this connection, the word “circuit” may be understood not only as hardware, such as an electronics circuit, but also as a function that may be implemented by software installed and executed on a computer.

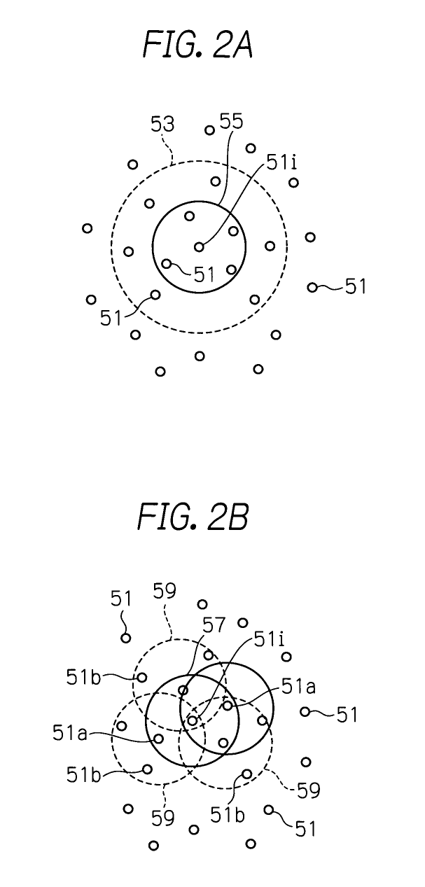

In the illustrative embodiment, the wireless communication node 1 forms a wireless communication network, like as shown in FIGS. 2A and 2B, together with a plurality of nodes which may be the same in configuration as the node 1. Each of the nodes 1 periodically transmits and receives control packets 21 and 23 to and from other nodes so as to mutually control the transmission timing. Thus, the respective nodes 1 can attain autonomous transmission timing control.

Each node 1 uses control packets 21 and 23 transmitted to and from the other nodes to perform the mutual control shown in and described with reference to FIG. 3 between the transmission timing control mechanism M1 and the path control mechanism M2. The adaptive communication control can thus be implemented even when the wireless communication environment changes.

The control packet receiver 11 is adapted to receive input control packets 21 transmitted from the other nodes and derive phase information therefrom to deliver the latter to the transmission timing control calculator 12 and the path control calculator 13. The transmission timing control calculator 12 is adapted to use the phase information 25 of the other nodes contained in the control packets 21 to divide the time period of one cycle by the neighboring nodes and the own node 1 into temporal sections, i.e. shares, required for data transmission to thereby control the transmission timing. In the context, the words “own node” are directed to a node of interest in the wireless communication network. Signals are designated with reference numerals of connections on which they are conveyed.

In the period of one cycle, the temporal section needed for data transmission by each node corresponds to a phase section in the operation of transmission timing control. More specifically, the time indicating a transmission timing is dealt with as a corresponding phase in the control processing. Hereinafter, the temporal section or phase section used by a node for data transmission in a period of one cycle is referred to as band obtained by that node. Likewise, the durations of a temporal section and a phase section are referred to as bandwidths.

The transmission timing control calculator 12 may be operative to calculate the transmission timing by any methods described in the aforementioned patent documents. This illustrative embodiment will be described as an example in an application where the transmission timing control calculator 12 generates a virtual phase of the node 1 per se as taught in the '946 patent to Date et al.

The path control calculator 13 is configured to use the control packets 21 received by the control packet receiver 11 from the other nodes, and carry out the processing for determining the destination node of a data packet 27.

The path control calculator 13 provides the transmission timing control calculator 12 with a bandwidth 29 needed for data transmission by its own node 1. The control calculator 12 provides the control calculator 13 with a bandwidth 31 obtained by the node 1. The reciprocal control is thus carried out. A further description on the reciprocal control will be made later.

The control packet transmitter 14 is dedicated to obtain calculation results 33 and 27 made by the transmission timing control calculator 12 and the path control calculator 13, respectively, to periodically assemble and transmit output control packets 23 containing the calculation results over the network.

As will be described later on, the control packet contains information on, e.g. the phase of the own node 1, which may include a virtual phase of the own node with respect to all other nodes existing within one-hop neighborhood, the depth and activity of the own node, and a relay-requested bandwidth in which the own node requests another node to relay, or transfer, a data packet.

The data packet transmitter/receiver 15 is configured to be responsive to phase information 41 of the own node 1 to receive input data packets 27 from other nodes, and transmit output data packets 29, if any, of data to be transmitted by the own node 1 or to be forwarded to another node. The destination node of a data packet 29 is determined on the basis of a calculation result by the path control calculator 13.

Next, with reference to some other figures, a description will be made on the operation of the transmission control according to the illustrative embodiment of the node 1. In operation, the transmission timing control calculator 12 uses control packets 21 received from the neighboring nodes within one hop from the own node 1 to execute the transmission timing control. The transmission timing control is carried out by using calculation results by the transmission timing control calculator 12 to control the timing at which its own node 1 transmits control packets 23.

The respective nodes 1 execute the autonomous control operation in parallel with each other so as to act as a reciprocal control mechanism between the nodes.

The control packet received by the own node 1 from another node A has the virtual phase of the node A added with respect to the other nodes residing within one-hop range from the node A. Thus, each node 1 can receive the control packets from the other nodes located in one-hop neighborhood to derive indirectly the phase information of the nodes existing in two-hop neighborhood.

The transmission timing control calculator 12 in turn uses the phase information 25 of the other nodes within two-hop neighborhood obtained at the timing of receiving the control packets 21 to generate a virtual phase model for the node concerned, and adjust the value of the virtual phase each time receiving a control packet 21. The transmission timing control calculator 12 performs the calculation by using the virtual phase with respect to the other nodes in two-hop neighborhood.

The transmission timings have to be shifted between the nodes by the time required for the respective nodes to transmit data packets. Since the communication loads of the nodes may generally be different from one another, the bandwidth needed by each node differs from one another. If each of the nodes could not obtain its necessary bandwidth, transmission collisions would occur between the nodes. In order to avoid such collisions, the transmission timing control calculator 12 carries out the calculation corresponding to the process of contending the bandwidth required for data transmission between the nodes.

In the following, an example of the calculation by the transmission timing control calculator 12 will be described. The calculation by the transmission timing control calculator 12 may be implemented, for instance, by using the following expressions (1.1) and (1.2) for modeling a system having nonlinear oscillators coupled.

$$\begin{matrix}\frac{d {θ}_{i} ( t )}{d t} = {ω}_{i} + \frac{K}{{\hat{N}}_{i}} {\sum }_{j = 1}^{{\hat{N}}_{i}} R ( Δ {\hat{θ}}_{ij} ( t ) ) + ξ ( {S}_{i} ( t ) ) & ( 1.1 ) \\ Δ {\hat{θ}}_{ij} ( t ) = {\hat{θ}}_{ij} ( t ) - {θ}_{i} ( t ) & ( 1.2 )\end{matrix}$$

where the variable t represents the time and the term θᵢ(t) represents the phase of the own node i at the time t.

An arithmetic is performed on the phase θᵢ (t) with mod 2π, which is a remainder of division by 2π, so as to make the phase θᵢ(t) always take a value in the range of 0≦θᵢ(t)<2π.

Furthermore, d/dt indicates derivation with respect to the time t, and dθᵢ(t)/dt denotes a state variable obtained by differentiating the phase θᵢ(t) with respect to the time t.

In the expressions, the term Δθ̂ᵢⱼ(t), where “̂” is hat, represents a phase difference between a virtual phase θ̂ᵢⱼ(t) with respect to the other node j and the phase θᵢ(t) of the own node i. Note that the phase difference Δθ̂ᵢⱼ(t) shall be resultant from adding 2π and then performing the arithmetic with mod 2π thereon so that the phase difference expediently takes a value in the range of 0≦Δθ̂ᵢⱼ(t)<2π.

The parameter ωᵢ is a specific angular oscillation frequency indicative of oscillation rhythm specific to a node i. By way of example, it is assumed that the values of ωᵢ of all nodes are made unified beforehand.

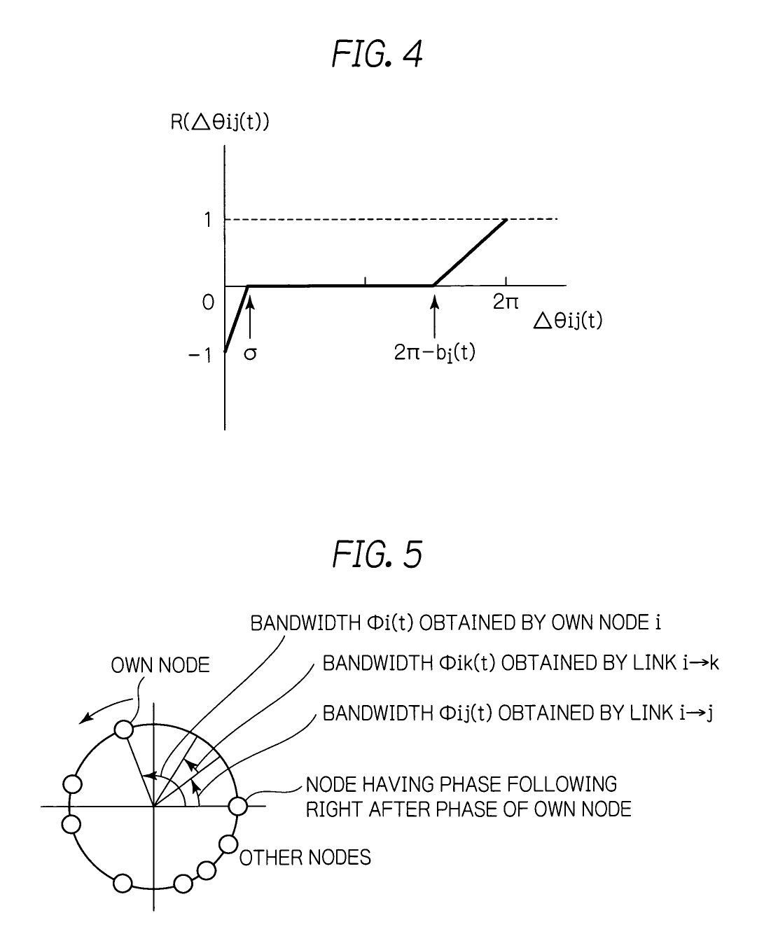

The function R(Δθ̂ᵢⱼ(t)) is a phase response function representing response characteristic that varies the oscillation rhythm of the own node in response to the phase difference Δθ̂ᵢⱼ(t). A specific example of function form of the phase response function R(Δθ̂ᵢⱼ(t)) is illustrated in FIG. 4.

The use of the phase response function R(Δθ̂ᵢⱼ(t)) shown in FIG. 4 causes a repulsion characteristic in phase between the own node and the other nodes according to the communication load, i.e. the bandwidth bᵢ(t) required for transmission by the own node 1. It is to be noted that, in the phase response function R(Δθ̂ᵢⱼ(t)) shown in FIG. 4, the range of phase difference, on which the repulsion characteristic acts, depends on the bandwidth bᵢ(t). Furthermore, a parameter σ in FIG. 4 is a constant parameter determined by way of experiment. The bandwidth bᵢ(t) has the following relationship with variables bᵢ^{(rel)}(t) and bᵢ^{(int)}(t), which will be described later with regard to the path control calculator 13.

bᵢ(t)=bᵢ^{(rel)}(t)+bᵢ^{(int)}(t) (2)

As described above, by producing a characteristic in the phase response function depending on the communication load, the determination of transmission path can be the condition of constraint in the transmission timing pattern forming process.

In the first expression (1.1), the notation N̂ᵢ in the term including the function R(Δθ̂ᵢⱼ(t)) indicates the total number of virtual phase models at the time t, and the parameter K indicates a parameter of coupling constant. The coupling constant parameter K determines the rate of the term including the function R(Δθ̂ᵢⱼ(t)) contributing to the temporal progress of the phase, and the value of the parameter K is defined by way of experiment.

The term ξ(Sᵢ (t)) has a function of building up stress when a relative phase difference between the own node and another node is small to cause a phase shift, or change of the state of the phase, at a randomized degree based on the value Sᵢ(t) of the built up stress.

Here, the relative phase difference is defined as below. Assuming that the phase difference is Δθ̂ᵢⱼ (t) and the relative phase difference is E,

if Δθ̂ᵢⱼ(t)≦π, then E=Δθ̂ᵢⱼ(t) (3.1)

if Δθ̂ᵢⱼ(t)>π, then E=2π−Δθ̂ᵢⱼ(t) (3.2)

that is, the term ξ(Sᵢ(t)) is a function representing a response characteristic of the value of the built up stress Sᵢ(t). The function form of the term ε(Sᵢ(t)) can be exemplified by the patent documents described earlier.

Now, the operation by the path control calculator 13 will be described. The path control calculator 13 performs the calculation corresponding to the contention between links on the bands obtained by the nodes at the time t.

Here, the word “link” refers to a link between a node of interest and a candidate destination node among the nodes existing in one-hop neighborhood. In general, each node may have a plurality of candidate destination nodes, so that there may exist a plurality of links. These links contend for the bands. In this illustrative embodiment, a link in which the node i designates a node j as a candidate destination node is referred to as the link {i to j}.

In the following, an example of calculation by the path control calculator 13 will be described. The calculation by the path control calculator 13 may be implemented by using, for example, the following expressions (1.3) to (1.8).

$$\begin{matrix}\frac{d {w}_{ij} ( t )}{d t} = [ {f}_{ij} ( t ) - {\sum }_{k = 1}^{N} {μ}_{jk}^{( i )} {w}_{ik} ( t ) ] {w}_{ij} ( t ) \\ ( where j = 1 , 2 , … , N ) & ( 1.3 ) \\ {φ}_{ij} ( t ) = \frac{{w}_{ij} ( t )}{{\sum }_{k = 1}^{N} {w}_{ik} ( t )} {Φ}_{i} ( t ) & ( 1.4 ) \\ {f}_{ij} ( t ) = {L}_{ij} {φ}_{ij} ( t ) {a}_{j} ( t ) & ( 1.5 ) \\ {a}_{j} ( t ) = \frac{{b}_{j}^{( tra )} ( t )}{{b}_{j}^{( rel )} ( t ) + {b}_{j}^{( int )} ( t )} & ( 1.6 ) \\ {b}_{j}^{( tra )} ( t ) = {\sum }_{k ∈ A} {L}_{jk} {φ}_{jk} ( t ) & ( 1.7 ) \\ {b}_{j}^{( rel )} ( t ) = {\sum }_{k ∈ B} {φ}_{mj} ( t ) & ( 1.8 )\end{matrix}$$

In the above expressions, the variable t represents the time, and the term wᵢⱼ(t) represents the ratio of a bandwidth which the link {i to j} will acquire in the bandwidth Φᵢ(t) which the node i has obtained at the time t, i.e. the ratio of band acquisition by the link {i to j} at the time t.

Furthermore, N indicates the total number of candidate destination nodes. A candidate destination node means a neighboring node located within one hop from the node i. In the illustrative embodiment, for simplicity, candidate destination nodes relative to the node i are selected from nodes existing in one-hop neighborhood of the node i and satisfying the condition that the depth thereof is less than that of the node i. The depth of the node i is represented by the smallest number of hops encountered from a sink node to the node i. The depth of the node i is hereinafter marked as Dᵢ.

In addition, φᵢⱼ(t) indicates a bandwidth acquired by the link {i to j} at the time t based on the values of Φᵢ(t) and wᵢⱼ(t). The bandwidth φᵢⱼ(t) corresponds to a bandwidth required for transmitting a data packet which the own node i requests the other node j to relay. As it is clear from the expression (1.4), the bandwidth Φᵢ(t) has a relationship with φᵢⱼ(t) indicated as the following expression (1.9).

$${Φ}_{i} ( t ) = {\sum }_{j = 1}^{N} {φ}_{ij} ( t ) \qquad ( 1.9 )$$

In the expression (1.3), d/dt represents derivation with respect to the time t, and dwᵢⱼ (t)/dt denotes a state variable obtained by differentiating the phase wᵢⱼ(t) with respect to the time t.

Furthermore, the parameter μⱼₖ⁽ⁱ⁾ is a constant defined by way of experiment. The constant parameter μⱼₖ⁽ⁱ⁾ indicates the extent of effect in the link {i to j} exerted by a link {i to k}, where k is not equal to j, at the time of executing the calculation corresponding to the contention between the links on the band Φᵢ(t) obtained by the node i at the time t.

The term fᵢⱼ(t) is an evaluation function defined by the expression (1.5). In the expression (1.5), the term Lᵢⱼ is a quality of the link {i to j}. The link quality Lᵢⱼ indicates a degree of success at which the node j successfully receives a packet sent from the node i, i.e. successibility of transmission.

The term aⱼ(t) is also an evaluation function defined by the expression (1.6). In the expression (1.6), termbⱼ^{(rel)}(t) is defined by the expression (1.8) and represents a bandwidth needed by the node j to transmit a data packet in a period of one cycle in response to a relay request issued by another node. In the expression (1.8), the letter B means a set of nodes which have issued relay requests to the node j during a period of one cycle. Note that nodes capable of sending a relay request to the node j are ones locating in the neighborhood of one-hop from the node j.

The term bⱼ^{(int)}(t) is a bandwidth needed by the node j to transmit in a period of one cycle a data packet produced in the own node. That is to say, the denominator in the expression (1.6) represents a bandwidth required to transmit a packet by the node j.

The term bⱼ^{(tra)}(t) is defined by the expression (1.7) and represents an effective transmission bandwidth to be used by the node j. In view of the link quality Lⱼₖ indicative of the degree of success of transmission, the bandwidth φⱼₖ(t) acquired by the link {j to k} can effectively be considered as a transmission bandwidth having its value provided by Lⱼₖφⱼₖ(t). That is, the expectation value of a bandwidth where a transmission will be succeeded can be expressed by Lⱼₖφⱼₖ(t). Thus, the summation of k in Lⱼₖφⱼₖ(t) represents the effective transmission bandwidth for the node j.

In the expression (1.7), the letter A is a set of nodes neighboring and existing in one hop from the node j and having the depth thereof shallower than that of the node j.

Furthermore, the term bⱼ^{(tra)}(t) is defined by using the link quality Lⱼₖ of the link {j to k} in the expression (1.7). The term may however be defined by using, instead of Lⱼₖ, an evaluation value or cost based on an accumulated additional values or accumulated integration value of the link quality relative to a path from the node j to the sink node over the node k. Although there are several paths routing the node k, the use of the accumulated additional values can determine the evaluation value by, for instance, selecting the minimum value.

In this way, the function aⱼ(t) defined by the expression (1.6) indicates the ratio between the bandwidth required for the transmission of data packets by the node j, which corresponds to the communication load, and the effective transmission bandwidth for the node j, which is the expectation value of the bandwidth where a transmission will be succeeded. Thus, the function aⱼ(t) represents a balance between the communication load on the node j at the time t and the effective transmission ability against the load. In the subsequent description, the function aⱼ(t) is referred to as a degree of activity of the node j at the time t. The lower the value of degree of activity, the worse the balance becomes so that data packets are more likely to be accumulated in the node j.

In addition, the function fᵢⱼ(t) defined by the expression (1.5) is a rate scale obtained from the product of an effective transmission bandwidth Lᵢⱼφᵢⱼ(t), or an expectation value of a bandwidth where a transmission will be succeeded, in the link {i to j} and the degree of activity aⱼ(t) of the node j. Thus, it can be said that the function fᵢⱼ(t) reflects the smoothness in packet flow in the link {i to j} at the time t. It is to be noted that the smoothness in packet flow in the link {i to j} is a rate scale that takes into consideration the tendency of occurrence of packet accumulation in the node j.

By performing the calculation on the path control operation using the expressions (1.3) to (1.8), one of the links of the own node i which has its smoothness in packet flow fᵢⱼ(t) larger has its bandwidth φᵢⱼ(t) increasing with time. In other words, the bandwidth φᵢⱼ(t) obtained by the link {i to j}, where j is an integer of 1 to N, increases or decreases with time depending on the smoothness in packet flow fᵢⱼ(t) of the link thereof. It corresponds to the contention of the band Φᵢ(t) obtained by the node i between the links of the own node i, see FIG. 5. In FIG. 5, the nodes rotate on the phase plane in the direction of the arrows. If the bandwidth φᵢⱼ(t) of one link {i to j} increases, the bandwidths φⱼₖ(t) of the other links {i to k} decrease accordingly, where k is not equal to j. The constant parameter μⱼₖ⁽ⁱ⁾ indicates the extent of effect in the link {i to j} exerted by a link {i to k}, where k is not equal to j, at the time of executing the calculation.

Consequently, the path control operation converges on either of the following two conditions: 1) only one of the links of the own node i acquires the entire bandwidth Φᵢ(t); or 2) several of the links of the own node i divide, or share, the bandwidth Φᵢ(t) at a certain ratio.

The condition of the above convergence is dependent on the constant parameter μⱼₖ⁽ⁱ⁾ and the value of the smoothness in packet flow fᵢⱼ(t). The value of the constant parameter μⱼₖ⁽ⁱ⁾ is experimentally determined in response under the requirements by an application.

The effect on the path control operation by the conditions of the transmission timing pattern formation is that the conflict occurring in the process of transmission timing pattern formation is reflected in the value of a degree of activity of a node. For example, if a conflict occurs in the node j, the value of the degree of activity aⱼ(t) decreases in the node j. It results in the decrease in the value of the smoothness in packet flow fᵢⱼ(t) in the link {i to j}, thereby causing the decrease of the bandwidth φᵢⱼ(t) obtained by the link {i to j}. It increases the bandwidths φⱼₖ(t) of the other links {i to k} in the node i, where k is not equal to j. In this way, the function is accomplished of decreasing a communication load on the node j in which a conflict is occurring and dispersing the load to the other nodes.

As a consequence, the state of the conflict occurring in the course of contention between the nodes over the band needed for data transmission exerts an effect on the process of determining a data packet transmission path, thereby acting on the decrease of conflict.

Now, description will be made on the operations of the control packet transmitter 14, the control packet receiver 11, and the data packet transmitter/receiver 15.

The control packet transmitter 14 adds control information to a control packet and transmits the packet 23 at the timing based on a result of calculation 33 made by the transmission timing control calculator 12. The result of calculation 33 includes phase information of the own and other nodes. The control packet receiver 11 receives control packets 21 transmitted by the other nodes to read out the control information from the received packets. The control information includes the phase information 25 of other nodes as well as information 35 on the degree of activity aⱼ(t) of the other node j, the relay-requested bandwidth φₘᵢ(t) in which the other node m requests the own node i for relaying, or transferring, a data packet, and the depth Dₖ of the other node k.

To the control packet 23, the control information 37 on the following terms is added as well as the phase information 33 of the neighboring nodes:

1) the degree of activity aᵢ(t) of the own node i;

2) the relay-requested bandwidth φᵢⱼ(t) required for transmitting a data packet which the own node i requests the other node j to relay, or transfer; and

3) the depth Dᵢ of the own node i.

The data packet transmitter/receiver 15 of the node uses the bandwidth φᵢⱼ(t) included in a result of calculation 39 made by the path control calculator 13 to transmit the data packets 29 including a relay request to the other nodes j. The data packet transmitter/receiver 15 also receives the data packets 27 of relay request sent from the other nodes.

The calculation of the above differential expressions (1.1), (1.2) and (1.3) can be implemented on anode in the form of software using a common numerical calculation method such as Euler's method or Runge-Kutta method. Such numerical calculation methods use a difference equation, or recurrence formula, obtained by differencing a differential equation, i.e. discretizing a time-continuous variable t, to calculate the changes in a state variable, or time-evolution. Furthermore, it is also possible to implement the differential expressions (1.1), (1.2) and (1.3) on the node in the form of hardware by configuring electrics having functions equivalent to these expressions.

As described above in relation to the illustrative embodiment, the transmission timing pattern forming process by the transmission timing control mechanism and the network topology forming process by the path control mechanism are carried out by constraining one another depending on the changes in the wireless network environment to gradually go on establishing a relationship to compromise with each other.

Consequently, the system quickly adapts itself to changes in the wireless communication environment to thereby allow the nodes to reciprocally control the transmission timing and path between the nodes, thereby achieving a multi-hop communications while avoiding the transmission collisions and congestions.

Next, an alternative embodiment of the communication control apparatus in accordance with the present invention will be described in detail with reference to the accompanying drawings. In the illustrative embodiment described above, the transmission timing control mechanism M1 shown in FIG. 3 is implemented by using the methods disclosed in the aforementioned patent documents. In the alternative embodiment, the transmission timing control mechanism M1 shown in FIG. 2 may be implemented by using the CSMA/CA (Carrier Sense Multiple Access/Collision Avoidance) scheme taught by Hidenori AOKI et al. That is, to the transmission timing control, the congestion control solution for a MAC (Media Access Control) layer of IEEE 802.11s may be applied. In this case, transmission timing control between nodes is implemented by controlling a back-off time. In the context, the back-off time means a waiting time until the start of transmission of a data packet when a transmission made by another node is detected by carrier sensing.

The system is so controlled that nodes 1 having larger communication load are made the back-off time thereof shorter. In the CSMA/CA scheme, the transmission timing is not scheduled between the nodes, so that transmission collisions cannot completely be avoided.

In the instant alternative embodiment, each node 1 observes the frequency of occurrence of transmission collisions on itself, i.e. the frequency at which the own node detected transmissions from other nodes when the own node tried transmissions. The information on the observation result is fed back as a constraint condition in the network topology forming process P2 in the path control mechanism M2. The path control mechanism M2 of the alternative embodiment may be implemented similarly to that of the illustrative embodiment described earlier.

The schematic internal structure of a node according to the alternative embodiment may be the same as illustrated in FIG. 1, and thus the alternative embodiment will be described also with reference to FIG. 1.

In the embodiment described earlier, control and data packets are periodically transmitted at the timings based on the result of calculation made by the transmission timing control calculator 12, FIG. 1. In the instant alternative embodiment, the transmission timing control calculator 12 serves as controlling the transmission timing based on the control rule defined as the CSMA/CA scheme. Thus, the alternative embodiment is adapted to transmit control and data packets at the transmission timings according to the CSMA/CA scheme.

The CSMA/CA scheme, however, does not handle phase information. Therefore, control packets do not include the phase information of a node. In addition, the transmission of packets is not periodic.

The present alternative embodiment may be inferior to the embodiment described earlier in terms of ability of avoiding transmission collisions, but has an advantage that the transmission timing control calculator 12 can be simplified in structure, thereby achieving a cost reduction in a node.

The entire disclosure of Japanese patent application No. 2009-151075 filed on Jun. 25, 2009, including the specification, claims, accompanying drawings and abstract of the disclosure is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A communication control apparatus for use in an own network node forming a wireless communication network together with another network node, comprising:
a transmission timing control calculator for contending with the other network node for a band in which a data signal is transmitted to control a transmission timing of the own network node;
a path control calculator for determining a transmission path for transmitting the data signal within a bandwidth obtained for the own network node by said transmission timing control calculator; and
a data signal transmitter for transmitting the data signal to a destination node on the transmission path determined by said path control calculator,
said transmission timing control calculator and said path control calculator providing each other with state information on processing, and using the provided state information as a constraint condition to control the band of the own network node and a band of a link between the own network node and the destination node.

2. The apparatus in accordance with claim 1, wherein
said path control calculator supplies said transmission timing control calculator with information about an amount of a communication load on the own network node due to a changes in the transmission path,
said transmission timing control calculator in turn using the amount of the communication load on the own network node as a constraint condition to control the band of the own network node with respect to the other network node,
said transmission timing control calculator supplying said path control calculator with the obtained bandwidth for the own network node,
said path control calculator in turn using a state of conflict of transmission timing based on the bandwidth of the own network node as a constraint condition to control the band between the links within the bandwidth of the own network node.

3. The apparatus in accordance with claim 1, further comprising a control information transmitter/receiver for transmitting to and receiving from the other network node at least control information on a relay-requested bandwidth to be used for requesting the own network node to relay the data signal by the other network node,
said path control calculator including a first evaluation value calculator responsive to a balance in the bandwidth of the own network node between the communication load on the destination node according to the relay-requested bandwidth included in the control information and an effective transmission bandwidth relative to the relay-requested bandwidth for calculating a first evaluation value indicative of the state of conflict of transmission timing.

4. The apparatus in accordance with claim 3, wherein said path control calculator further includes:
a second evaluation value calculator responsive to an expectation value of a bandwidth where a transmission of the data signal to the destination node is successful and the first evaluation value of the link calculated by said first evaluation value calculator for calculating a second evaluation value of the link indicating a flow state of the data signal to the destination node; and
a link band determiner operative in response to the second evaluation value of the link calculated by said second evaluation value calculator for determining the bands between the links within the bandwidth of the own network node.

5. The apparatus in accordance with claim 3, wherein said control information transmitter/receiver adds the first evaluation value and position information of the own network node to the control information to transmit the resultant control information to the other network nodes.

6. A wireless communication network formed by a plurality of network nodes, each of which includes a communication control apparatus comprising:
a transmission timing control calculator for contending with another network node for a band in which a data signal is transmitted to control a transmission timing of an own network node on which said apparatus is included;
a path control calculator for determining a transmission path for transmitting the data signal within a bandwidth obtained for the own network node by said transmission timing control calculator; and
a data signal transmitter for transmitting the data signal to a destination node on the transmission path determined by said path control calculator,
said transmission timing control calculator and said path control calculator providing each other with state information on processing, and using the state information provided as a constraint condition to control the band of the own network node and a band of a link between the own network node and the destination node.

7. A communication control program for causing, when installed and running on a computer, the computer to function as a communication control apparatus for use in an own network node forming a wireless communication network together with another network node, said apparatus comprising:
a transmission timing control calculator for contending with the other network node for a band in which a data signal is transmitted to control a transmission timing of the own network node;
a path control calculator for determining a transmission path for transmitting the data signal within a bandwidth obtained for the own network node by said transmission timing control calculator; and
a data signal transmitter for transmitting the data signal to a destination node on the transmission path determined by said path control calculator,
said transmission timing control calculator and said path control calculator providing each other with state information on processing, and using the provided state information as a constraint condition to control the band of the own network node and a band of a link between the own network node and the destination node.
